(19) United States
(12) Patent Application Publication
(10) Pub. No.: US 2007/0146052 A1
(43) Pub. Date: Jun. 28, 2007

(54) Charge pump

(76) Inventor: Dae-Seok Byeon, Yongin-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/489,476

(22) Filed: Jul. 20, 2006

(30) Foreign Application Priority Data
Dec. 26, 2005 (KR) 2005-129799

(51) Int. Cl. G05F 1/10

(52) U.S. Cl. 327/536

(57) ABSTRACT

A charge pump is disclosed. The charge pump comprises a plurality of first voltage boosting circuits (VBCs), each comprising a first output node and a precharge circuit adapted to precharge the first output node, and at least one second VBC connected in series with the plurality of first VBCs, wherein each of the at least one second VBC does not comprise any precharge circuit.

### BACKGROUND OF THE INVENTION

1. Field of the Invention

Embodiments of the invention relate to a charge pump adapted for use within a semiconductor memory device. In particular, embodiments of the invention relate to a charge pump adapted for use within a flash memory device requiring a high voltage during program and erase operations.

This application claims priority to Korean Patent Application 2005-129799, filed on Dec. 26, 2005, the subject matter of which is hereby incorporated by reference in its entirety.

2. Description of Related Art

Semiconductor memory devices may be generally categorized as either volatile semiconductor memory devices or non-volatile semiconductor memory devices. In addition, volatile semiconductor memory devices fall either in the class of dynamic random access memories (DRAMs) or the class of static random access memories (SRAMs). A volatile semiconductor memory device loses its stored data when the power supply to the volatile semiconductor memory device is interrupted. However, a non-volatile memory device retains its stored data even when the power supply of the non-volatile semiconductor memory device is interrupted. Thus, non-volatile semiconductor memory devices are widely used to store data that needs to be retained regardless of whether there is an interruption in the semiconductor memory device's power supply. Mask read-only memories (MROMs), programmable read-only memories (PROMs), erasable programmable read-only memories (EPROMs), and electrically erasable programmable read-only memories (EEPROMs) are all types of non-volatile memories.

However, data cannot be readily re-written in MROMs, PROMs, or EPROMs because read and write operations cannot be freely performed by normal users in MROMs, PROMs, or EPROMs. On the other hand, EEPROMs are being used increasingly in systems having system programming that requires continuous updating, and in auxiliary memory devices. In particular, flash EEPROMs may be advantageously used as mass storage devices because the integration density of flash EEPROMs is higher than that of conventional EEPROMs. Among flash EEPROMs, NAND-type flash EEPROM (referred to hereafter as “NAND flash memory”) has a much higher integration density than a NOR-type or AND-type flash EEPROM.

It is well known that conventional flash memory devices require operating voltages higher than standard power supply voltages in order to perform erase, program, and/or read operations. These high voltages have routinely been provided by various pump circuits disposed in flash memory devices. Charge pump circuits are widely used to “boost” a low-level voltage to a high-level voltage. The use of internal pump circuits is deemed preferable to the external provision of high voltages since externally provided high voltages tend to create corresponding electric fields that stress various aspects of flash memory devices and may cause malfunctions or damage to elements such as transistors. Accordingly, flash memory devices generate high voltages internally (i.e., inside the chip), in accordance with design rules prescribing transistor device characteristics such as threshold voltage, breakdown voltage, etc.

Higher integration density, higher performance, and lower power consumption are each goals that are being pursued in the design of semiconductor memory devices. With the ever-increasing demand for smaller semiconductor devices, the size of elements disposed in a chip and the design rule for semiconductor memory devices are decreasing. Therefore, breakdown voltages for the elements in a chip have upper limits. If the voltage that an element will output, e.g., a high voltage generated from a charge pump, increases to a level that is above the level of a breakdown voltage, then the voltage of that element's output may be clamped to voltage level that is lower than a target level. When voltages below a target level are produced in a flash memory device, the flash memory device may not operate stably. Accordingly, a charge pump capable of generating a high voltage that has a desired voltage level and that is not adversely affected by a breakdown voltage is needed.

### SUMMARY OF THE INVENTION

Embodiments of the invention provide a charge pump adapted to output a high voltage that is not adversely affected by a breakdown voltage.

In one embodiment, the invention provides a charge pump comprising a plurality of first VBCs each comprising a first output node and a precharge circuit adapted to precharge the first output node, and at least one second VBC, wherein each of the at least one second VBC does not comprise any precharge circuit.

In another embodiment, the invention provides a charge pump comprising a first voltage boosting circuit (VBC) and a final VBC. The first VBC comprises a first output node adapted to provide a first boosted voltage to a subsequent VBC relative to the first VBC, and a first precharge circuit adapted to precharge the first output node, wherein the first VBC is adapted to output the sum of a first preceding boosted voltage input by a first preceding VBC relative to the first VBC and an internally generated voltage as the first boosted voltage. The final VBC comprises a final output node, and the final VBC does not comprise any precharge circuit.

### BRIEF DESCRIPTION OF THE DRAWINGS

Embodiments of the invention will be described hereinafter with reference to the accompanying drawings, in which like reference symbols refer to like or similar elements throughout. In the drawings:

FIG. 1 is a circuit diagram of a charge pump in accordance with an embodiment of the invention;

FIG. 2 is a circuit diagram of a charge pump in accordance with another embodiment of the invention;

FIG. 3 is a graph illustrating charge pump setup times in accordance with whether or not the charge pumps comprise initialize transistors;

FIG. 4 is a graph illustrating a boosted voltage generated by an exemplary first charge pump comprising initialize transistors, wherein a respective initialize transistor is connected to each output node of the exemplary first charge pump, and illustrating a boosted voltage generated by an exemplary second charge pump, wherein the exemplary second charge pump is a charge pump in accordance with an embodiment of the invention;

FIG. 5 is a graph illustrating a boosted voltage generated by the exemplary first charge pump; and,

FIG. 6 is a graph illustrating a boosted voltage generated by the exemplary second charge pump.

### DESCRIPTION OF EMBODIMENTS

A charge pump in accordance with an embodiment of the invention comprises a final output node wherein no initialize transistor is connected to the final output node. In accordance with another embodiment of the invention, a charge pump comprises a plurality of voltage boosting circuits (VBCs), wherein each VBC comprises an output node, the plurality of VBCs comprises a final VBC, and no initialize transistor is connected to the output node of the final VBC (i.e., the final output node) or to the output node(s) of at least one consecutively preceding VBC relative to the final VBC. An initialize transistor (i.e., a precharge circuit) performs a precharge operation to precharge a corresponding output node to a predetermined level prior to the performance of a boosting operation. However, an operation range of the initialize transistor may be limited by a breakdown voltage BV. Therefore, in accordance with embodiments of the invention, no initialize transistor is connected to at least a final output node of a charge pump in order to prevent a final boosted voltage VPP of the charge pump from being clamped by breakdown voltage BV.

Embodiments of the invention will be described hereinafter with reference to embodiments of a charge pump adapted to generate a high voltage needed in a non-volatile memory device such as a flash memory device. However, the embodiments described herein are exemplary and may be modified and changed without departing from the scope of the invention as described by the accompanying claims.

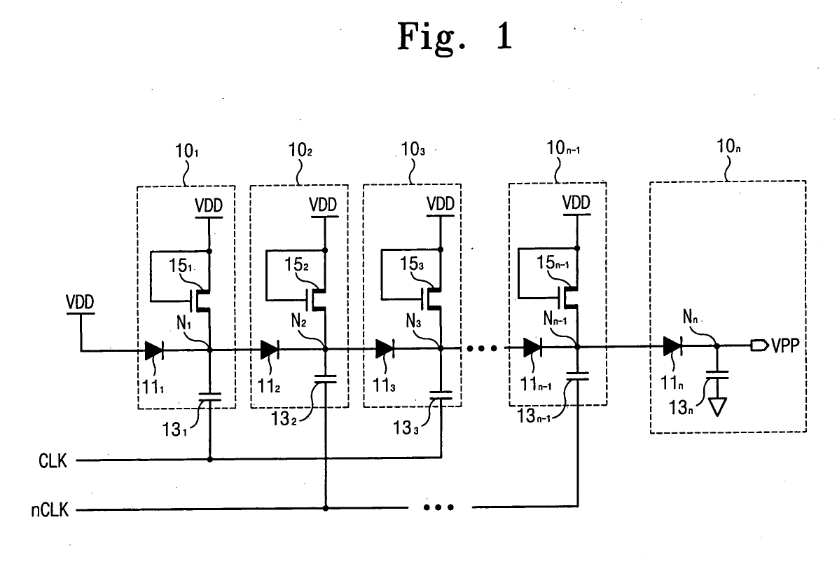

FIG. 1 is a circuit diagram of a charge pump in accordance with an embodiment of the invention. The charge pump comprises a number “n” of VBCs 10₁-10ₙ connected in series (i.e., serially). Each of VBCs 10₁-10ₙ comprises one of diodes 11₁-11ₙ, respectively, and one of capacitors 13₁-13ₙ, respectively. The number “n” of VBCs 10₁-10ₙ may be set in accordance with a desired number of voltage boosting operations and the voltage level of the target voltage. The number “n” is a positive integer, and in the embodiment illustrated in FIG. 1, “n” is an odd number; however, “n” may be an even number.

Diodes 11₁-11ₙ are charge transfer elements adapted to control the flow of input charges so that all of the input charges move in one direction (i.e., to control input charges to migrate in one direction). A power supply voltage VDD is applied to a first diode 11₁ of a first VBC 10₁, which is one of VBCs 10₁-10ₙ, which are connected in series. First diode 11₁ supplies power supply voltage VDD to a first output node N₁ of first VBC 10₁. The voltage supplied to first output node N₁ drops from power supply voltage VDD to the level of the threshold voltage of diode 11₁ (i.e., drops as much as a threshold voltage of diode 11₁). A first boosted voltage output by first VBC 10₁ is input to a second diode 11₂ of a second VBC 10₂ connected in series to first VBC 10₁. In the series of VBCs 10₁-10ₙ, second VBC 10₂ is the next VBC connected in series to first VBC 10₁.

VBCs 10₁-10ₙ comprise output nodes N₁-Nₙ, respectively, and capacitors 13₁-13ₙ are connected to output nodes N₁-Nₙ, respectively. Due to a charge sharing operation or a coupling characteristic between capacitors 13₁-13ₙ, a final boosted voltage VPP is output through a final output node Nₙ. To generate final boosted voltage VPP, a voltage is raised through intermediate voltages to the voltage level of final boosted voltage VPP by VBCs 10₁-10ₙ The nearer an output node Nₓ is to final output node Nₙ in a series of output nodes N₁-Nₙ, the higher the voltage level of output node Nₓ, wherein “x” is an integer value between 1 and n, inclusive. Consequently, final boosted voltage VPP output through final output node Nₙ is greater than each of the voltages output by VBCs 10₁-10ₙ₋₁. Each of capacitors 13₁-13ₙ₋₁ respectively receives a clock signal CLK or an inverted clock signal nCLK so that coupling will occur in capacitors 13₁-13ₙ₋₁ (i.e., so that charges will pass between adjacently coupled capacitors). For example, clock signal CLK is applied to the (2a-1)^{th} VBCs (i.e., 10₁, 10₃, . . . , etc.), and inverted clock signal nCLK is applied to the 2a^{th} VBCs (i.e., 10₂, 10₄, . . . , etc.), wherein “a” is a positive integer. Each capacitor 13ₓ of capacitors 13₁-13ₙ₋₁ accumulates a charge in response to either an input clock signal CLK or an input inverted clock signal nCLK and supplies the accumulated charge to the corresponding output node Nₓ of output nodes N₁-Nₙ₋₁, to which diodes 11₁-11ₙ₋₁ also supply charge, respectively. An output voltage of a VBC is input to a subsequent VBC relative to the VBC. As used herein, when a first VBC is said to be a “subsequent VBC relative to” a second VBC, it means that the first VBC directly follows the second VBC in the series of VBCs and that the first VBC provides a voltage directly to the second VBC. As used herein, terms such as “first,” “second,” etc., are only used for convenience of description.

Each of diodes 11₁-11ₙ disposed in VBCs 10₁-10ₙ, respectively, may be replaced with a field effect transistor having a drain and gate connected to a common potential (i.e., tied on a silicon bulk). In such an embodiment, since the well region of each transistor is electrically isolated from the exterior, each of diodes 11₁-11ₙ may be a low-voltage transistor.

In the charge pump of FIG. 1, in accordance with an embodiment of the invention, initialize transistors 15₁-15ₙ₋₁ are connected to output nodes N₁-Nₙ₋₁ of VBCs 10₁-10ₙ₋₁, respectively, to reduce a setup time of the charge pump. However, to prevent final boosted voltage VPP from being clamped by a breakdown voltage BV, there is no initialize transistor connected to final output node Nₙ. That is, an initialize transistor is connected to each of output nodes N₁-Nₙ except for output node Nₙ so that the setup time of the charge pump may be reduced without final boosted voltage VPP being clamped by a breakdown voltage BV. In another embodiment, in addition to final output node Nₙ, there may also be no initialize transistor connected to the output node(s) of at least one consecutively preceding VBC relative to final VBC 10ₙ (e.g., output node Nₙ₋₁ of VBC 10ₙ₋₁).

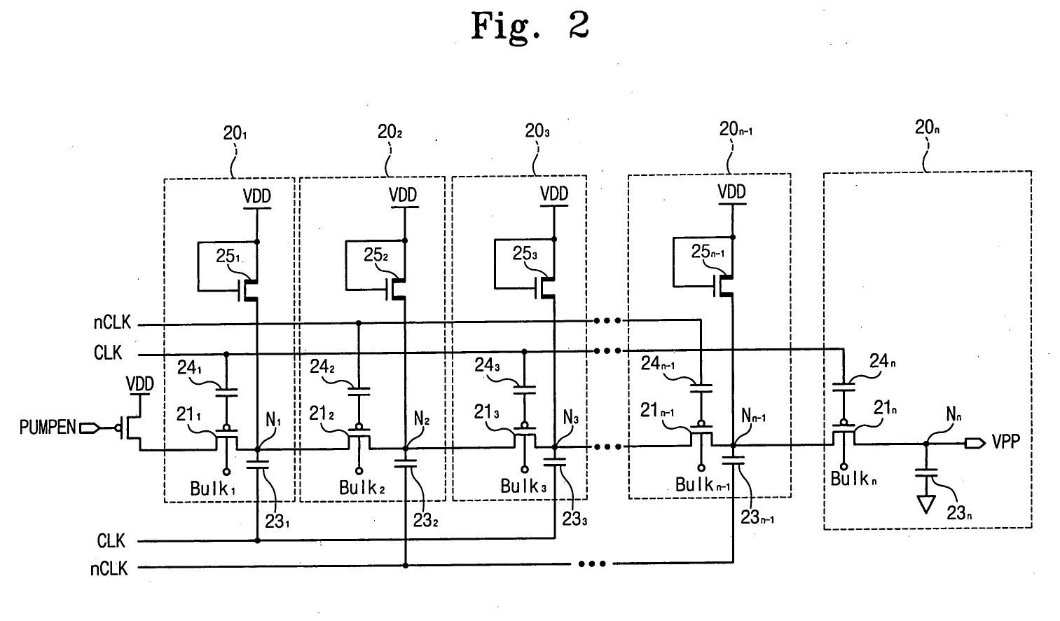

FIG. 2 is a circuit diagram of a charge pump in accordance with another embodiment of the invention. The charge pump of FIG. 2 comprises a number “n” of VBCs 20₁-20ₙ connected in series. A charge supply element adapted to supply charges is connected to VBCs 20₁-20ₙ, and the supply of charges is turned ON/OFF in response to a pump enable signal PUMPEN. In the embodiment illustrated in FIG. 2, VBCs 20₍₂ₐ₋₁₎ operate in response to clock signal CLK, and VBCs 20₂ₐ operate in response to inverted clock signal nCLK, wherein “a” is a positive integer. In an alternative embodiment, VBCs 20₍₂ₐ₋₁₎ operate in response to inverted clock signal nCLK, and VBCs 20₂ₐ operate in response to clock signal CLK. Also, clock signal CLK and inverted clock signal nCLK have opposite phases. The number “n” is a positive integer, and in the embodiment illustrated in FIG. 2, “n” is an odd number; however, “n” may be an even number.

Each VBC 20ᵢ of VBCs 20₁-20ₙ, wherein “i” is a positive integer, comprises two capacitors 23ᵢ and 24ᵢ and a PMOS transistor 21ᵢ. PMOS transistor 21ᵢ is a low-voltage transistor and is used as a charge transfer element, like a diode 11ᵢ shown in FIG. 1. Current paths of PMOS transistors 21₁-21ₙ of VBCs 20₁-20ₙ, respectively, are connected in series, and bulks (or bulk terminals) Bulkᵢ of PMOS transistors 21₁-21ₙ are each maintained in a floating state.

Similar to the charge pump shown in FIG. 1, the charge pump shown in FIG. 2 comprises initialize transistors 25₁-25ₙ₋₁ to reduce the setup time of the charge pump. Initialize transistors 25₁-25ₙ₋₁ are respectively connected to output nodes N₁-Nₙ₋₁ of VBCs 20₁-20ₙ₋₁; however, a final VBC 20ₙ does not comprise an initialize transistor connected to a final output node Nₙ.

Referring to FIGS. 1 and 2, initialize transistors 15₁-15ₙ₋₁ precharge output nodes N₁-Nₙ₋₁ of corresponding VBCs 10₁-10ₙ₋₁ to a voltage level of VDD-Vth.hvn before a pumping operation is performed, and initialize transistors 25₁-25ₙ₋₁ precharge output nodes N₁-Nₙ₋₁ of corresponding VBCs 20₁-20ₙ₋₁ to a voltage level of VDD-Vth.hvn before a pumping operation is performed, wherein VDD is a power supply voltage and Vth.hvn is a threshold voltage of each of initialize transistors 15₁-15ₙ₋₁ and 25₁-25ₙ₋₁. Therefore, when generating a target voltage using a charge pump in accordance with an embodiment of the invention, it is possible to reduce the setup time required after a pumping operation begins. In the charge pump shown in FIG. 1, no initialize transistor is connected to final output node Nₙ of final VBC 10ₙ, and a precharge voltage of final output node Nₙ is determined in accordance with an initial precharge voltage of a preceding output node Nₙ₋₁ of a preceding VBC 10ₙ₋₁ relative to final VBC 10ₙ. That is, final output node Nₙ is precharged to a precharge voltage and the level of the precharge voltage corresponds to the initial precharge voltage of preceding output node Nₙ₋₁. As used herein, when a first VBC is said to be a “preceding VBC relative to” a second VBC, it means that the first VBC directly precedes the second VBC in the series of VBCs and provides a voltage directly to the second VBC. In the charge pump shown in FIG. 2, however, the precharge voltage of final node Nₙ is not affected by the initial precharge voltage of a preceding output node Nₙ₋₁ of a preceding VBC 10ₙ₋₁ relative to final VBC 20ₙ because, before a pumping operation is performed, current does not flow between adjacent transistors 21ₙ₋₁ and 21ₙ because of the characteristic functionality of transistors (i.e., in accordance with an operating characteristic of a transistor). Accordingly, in the charge pump shown in FIG. 2, a precharge voltage of an output node of a first VBC does not affect the voltage of an output node of a subsequent VBC relative to the first VBC.

FIG. 3 is a graph illustrating charge pump setup times in accordance with whether or not the charge pumps comprise initialize transistors. As used herein, “setup time” means the amount of time required to allow an output of a charge pump to reach a target voltage level VPP_Target. An initializing charge pump comprises initialize transistors 15₁-15ₙ or 25₁-25ₙ connected within the initializing charge pump, and a non-initializing charge pump does not comprise initialize transistors. A final boosted voltage VPP of the initializing charge pump reaches target voltage level VPP_Target significantly sooner than a final boosted voltage VPP_no_init of the non-initializing charge pump, and thus the initializing charge pump has a significantly shorter setup time than the non-initializing charge pump. However, the possible configurations described with regard to FIG. 3 are merely exemplary embodiments of the invention, and initialize transistors 15₁-15ₙ and 25₁-25ₙ may alternatively be depletion transistors, P-type high-voltage transistors, or other precharge circuits.

The configuration of a charge pump in which no initialize transistor is connected to a final output node of a final VBC in the charge pump will be described below.

During programming and erase operations, a flash memory device requires a high voltage, i.e., a boosted voltage VPP, of at least 23 volts. To enable a charge pump to output boosted voltage VPP of at least 23 volts, a voltage substantially equal to at least 23 volts should be generated at final output node Nₙ. Accordingly, an initialize transistor directly coupled to a high voltage by being connected to an output node having a high voltage, and especially an initialize transistor connected to final output node Nₙ, should be designed to have a breakdown voltage BV high enough that the initialize transistor will not clamp the high voltage to a level below at least 23 volts.

More specifically, to enable a charge pump to output a voltage of a desired level, the level of a breakdown voltage BV affecting an initialize transistor should be higher than boosted voltage VPP by VDD*α, i.e., BV≧VPP+VDD*α, wherein α is a coupling ratio of the charge pump. Generally, the α used in the charge pump has a value ranging from 0.5 to 0.8. For example, if a boosted voltage VPP is 23 volts and the power supply voltage VDD is 2.5 volts, breakdown voltage BV must be at least 25 volts (i.e., 23+(2.5*0.8). So, to enable a charge pump to generate a boosted voltage VPP of 23 volts, breakdown voltage BV should be guaranteed to be at least 25 volts. If breakdown voltage BV is not guaranteed to be at least 25 volts, an output of the charge pump is clamped by breakdown voltage BV causing boosted voltage VPP to drop below a desired level. Unfortunately, because of the recent trend toward reducing the design rule in semiconductor devices, the maximum breakdown voltage BV has nearly been reached. Moreover, it is very difficult to increase breakdown voltage BV over the level desired for the charge pump (e.g., 25 volts or higher).

Therefore, by regulating the number of initialize transistors connected to output nodes of VBCs rather than increasing breakdown voltage BV, boosted voltage VPP is prevented from being clamped below the desired level for boosted voltage VPP in charge pumps in accordance with embodiments of the invention. In one embodiment of the invention, for example, an initialize transistor is not connected to final output node Nₙ. In another embodiment, no initialize transistor is connected to final output node Nₙ of final VBC 10ₙ or the output node(s) Nᵢ of at least one consecutively preceding VBC 10ᵢ relative to final VBC 10ₙ. In yet another embodiment, no initialize transistor is connected to final output node Nₙ of final VBC 20ₙ or the output node(s) Nᵢ of at least one consecutively preceding VBC 20ᵢ relative to final VBC 20ₙ. As used herein, when it is said that no initialize transistor is connected to “the output node(s) of at least one consecutively preceding VBC relative to the final VBC” it means that no initialize transistor is connected to an output node of a first preceding VBC relative to the final VBC, and an initialize transistor may not be connected to an output node of a second preceding VBC relative to the first preceding VBC, etc., possibly continuing back along a plurality of VBCs connected in series (e.g., 10₁-10ₙ or 20₁-20ₙ) to an output node Nᵢ such that no initialize transistor is connected to output node Nᵢ, final output node Nₙ, or any output node of the VBCs disposed in series between the VBC comprising output node Nᵢ and the final VBC. In a series of VBCs (e.g., 10₁-10ₙ) in a charge pump in accordance with an embodiment of the invention, the nearer a VBC (e.g., a VBC 10ᵢ) is disposed in the series to a final VBC (e.g., final VBC 10ₙ) in the series, the higher the level of the voltage output by the VBC. Thus, the nearer a VBC is disposed in series to final VBC in a series of VBCs, the more likely it is that the VBC is affected by breakdown voltage BV. In accordance with the configuration described above, the voltage of an output node that is not connected to an initialize transistor is not affected by breakdown voltage BV; and thus, not connecting an initialize transistor to the output node prevents boosted voltage VPP from being clamped in accordance with breakdown voltage BV.

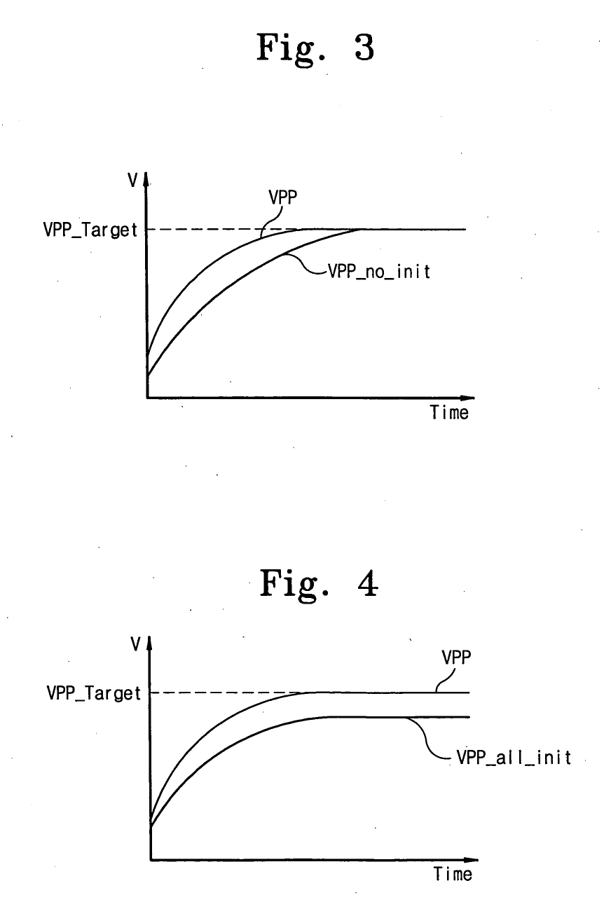

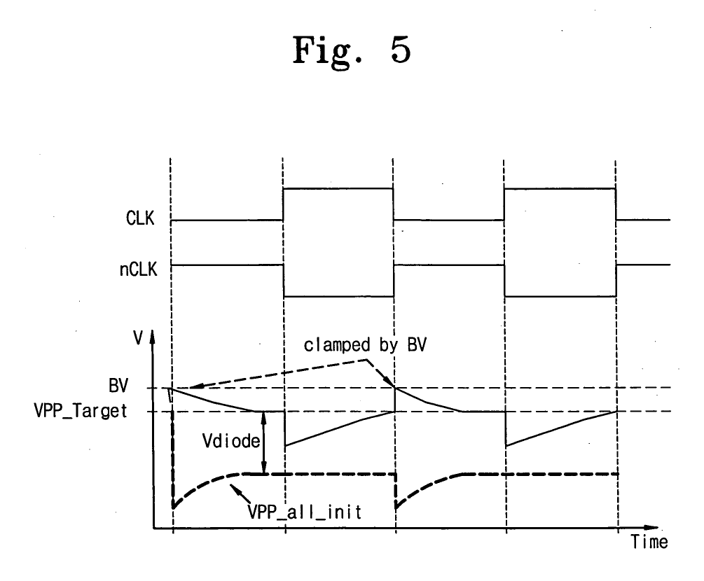

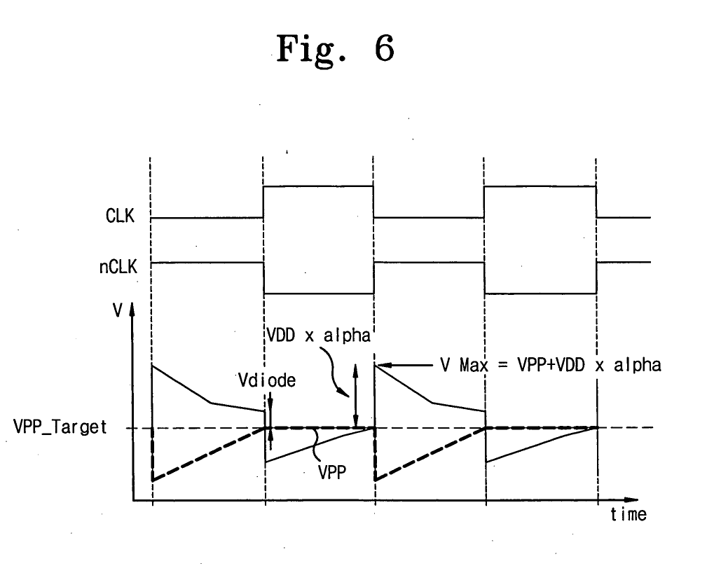

FIG. 4 is a graph illustrating a boosted voltage VPP_all_init generated by an exemplary first charge pump comprising initialize transistors, wherein a respective initialize transistor is connected to each output node of the exemplary first charge pump, and illustrating a boosted voltage VPP generated by an exemplary second charge pump, wherein the exemplary second charge pump is a charge pump in accordance with an embodiment of the invention. FIG. 5 is a graph illustrating boosted voltage VPP_all_init generated by the exemplary first charge pump described previously, and FIG. 6 is a graph illustrating boosted voltage VPP generated by the exemplary second charge pump described previously.

FIGS. 4 and 5 show that when initialize transistors are respectively connected to each output node of the first charge pump, boosted voltage VPP_all_init generated by the first charge pump is lower than target boosted voltage VPP_Target. Boosted voltage VPP_all_init is lower than target boosted voltage VPP_Target because an initialize transistor connected to final output node Nₙ of the first charge pump is affected by a breakdown voltage BV and clamps down final boosted voltage VPP_all_init by an amount equal to a diode voltage Vdiode. Therefore, the resulting final boosted voltage VPP_all_init is less than target boosted voltage VPP_Target (i.e., less than target boosted voltage VPP_Target by an amount equal to diode voltage Vdiode).

FIGS. 4 and 6 show that when no initialize transistor is connected to final output node Nₙ of the second charge pump, boosted voltage VPP generated by the second charge pump reaches target boosted voltage VPP_target. In particular, since no initialize transistor is connected to final output node Nₙ of the second charge pump, the voltage of final output node Nₙ of the second charge pump is not affected by breakdown voltage BV. Therefore, boosted voltage VPP of the second charge pump reaches target boosted voltage VPP_target.

In the charge pump illustrated in FIG. 1, a precharge voltage (i.e., an initial precharge voltage) of final output node Nₙ, which is not connected to any initialize transistor, is determined in accordance with a precharge voltage of an output node Nₙ₋₁ of a preceding VBC 10ₙ₋₁ relative to final VBC 10ₙ. Specifically, the initial precharge voltage of output node Nₙ₋₁ of preceding VBC 10ₙ₋₁ is VDD-Vth.hvn, and the precharge voltage of final output node Nₙ is (VDD-Vth.hvn)-Vdiode. For example, if VDD, Vth.hvn, and Vdiode are 2.5 volts, 0.7 volts, and 0.6 volts, respectively, the precharge voltage of output node Nₙ₋₁ is 1.8 volts and the precharge voltage of final output node Nₙ is 1.2 volts. Thus, although no initialize transistor is connected to final output node Nₙ, final output node Nₙ is precharged in accordance with a precharge voltage (e.g., 1.8 volts) of output node Nₙ₋₁ of preceding VBC 10ₙ₋₁. So, having no initialize transistor connected to final output node Nₙ will have little effect on the setup time of the charge pump shown in FIG. 1. Thus, the setup time of final boosted voltage VPP of the charge pump shown in FIG. 1, which is a charge pump in accordance with an embodiment of the invention, is substantially the same as the setup time of the final boosted voltage VPP of the initializing charge pump discussed with reference to FIG. 3.

On the other hand, a precharge voltage of final output node Nₙ of the charge pump shown in FIG. 2 is not affected by a precharge voltage of output node Nₙ₋₁ of the preceding VBC 10ₙ₋₁ relative to final VBC 10ₙ because, in accordance with the characteristic functionality of transistors (i.e., an operation characteristic of a transistor), current does not flow between adjacent transistors 21ₙ₋₁ and 21ₙ before a pumping operation is performed. Therefore, in the charge pump shown in FIG. 2, the precharge voltage of an output node of a first VBC does not affect the precharge voltage of an output node of a subsequent VBC relative to the first VBC. However, in the charge pump shown in FIG. 2, there is only one output node that is not precharged during an initial operation (i.e., only final output node Nₙ is not precharged). Thus, the setup time of final boosted voltage VPP of the charge pump shown in FIG. 2 is substantially the same as the setup time of final boosted voltage VPP of the initializing charge pump discussed with reference to FIG. 3.

As described above, in a charge pump in accordance with an embodiment of the invention, no initialize transistor is connected to final output node Nₙ. Therefore, it is possible to eliminate the adverse effect of a breakdown voltage BV, which limits the operating range of an initialize transistor, on a voltage output by the charge pump. As a result, final boosted voltage VPP of the charge pump is not clamped by breakdown voltage BV, and target voltage VPP_Target may be generated by the charge pump stably. Additionally, in accordance with embodiments of the invention only a small minority of output nodes may not be respectively connected to initialize transistors, so the setup time of the charge pump may not be adversely affected by not connecting an initialize transistor to every output node.

Embodiments of a charge pump in which no initialize transistor is connected to a final output node have been described; however, the embodiments described previously are exemplary embodiments and may be modified and changed without departing from the scope of the invention as defined by the accompanying claims. For example, a charge pump in accordance with an embodiment of the invention may be configured such that no initialize transistor is connected to the final output node of a final VBC, or to the output node(s) of at least one consecutively preceding VBC relative to the final VBC.

In accordance with embodiments of the present invention, it is possible to substantially prevent final boosted voltage VPP of a charge pump from being clamped by breakdown voltage BV without substantially affecting the setup time of the charge pump. Thus, a semiconductor memory device such as a flash memory device, which requires a high voltage, may be able to stably perform programming and/or erase operations using a charge pump in accordance with an embodiment of the invention.

Although embodiments of the invention have been described herein, it will be apparent to those skilled in the art that various substitutions, modifications, and changes may be made to the embodiments described previously without departing from the scope of the invention as defined by the accompanying claims.

What is claimed is:

1. A charge pump comprising:
a plurality of first voltage boosting circuits (VBCs), wherein each first VBC comprises a first output node and a precharge circuit adapted to precharge the first output node; and,
at least one second VBC connected in series with the plurality of first VBCs, wherein each of the at least one second VBC does not comprise any precharge circuit.

2. The charge pump of claim 1, wherein each second VBC comprises a second output node, and a selected first VBC of the plurality of first VBCs is adapted to precharge each second output node in accordance with a precharge voltage of the first output node of the selected first VBC.

3. The charge pump of claim 1, wherein no precharge voltage of any first output node of any first VBC affects any second VBC.

4. The charge pump of claim 1, wherein each of the first VBCs comprises:
a first capacitor adapted to generate a first internally generated voltage in response to a first clock signal; and,
a first charge transfer element adapted to receive a first preceding boosting voltage from a first preceding VBC relative to the first VBC and provide the first preceding boosting voltage to the first output node of the first VBC.

5. The charge pump of claim 4, wherein each of the second VBCs comprises:
a second capacitor adapted to generate a second internally generated voltage in response to a second clock signal; and,
a second charge transfer element adapted to receive a second preceding boosting voltage from a second preceding VBC relative to the second VBC and provide the second preceding boosting voltage to a second output node of the second VBC.

6. The charge pump of claim 5, wherein each of the first and second charge transfer elements is a low-voltage transistor or a diode.

7. A charge pump comprising:
a first voltage boosting circuit (VBC) comprising:
a first output node adapted to provide a first boosted voltage to a subsequent VBC relative to the first VBC; and,
a first precharge circuit adapted to precharge the first output node,
wherein the first VBC is adapted to output the sum of a first preceding boosted voltage input by a first preceding VBC relative to the first VBC and an internally generated voltage as the first boosted voltage; and,
a final VBC comprising a final output node and connected in series with the first VBC, wherein the final VBC does not comprise any precharge circuit.

8. The charge pump of claim 7, wherein the first precharge circuit is a high-voltage transistor.

9. The charge pump of claim 7, wherein the first VBC comprises:
a capacitor adapted to generate the internally generated voltage in response to a clock signal; and,
a charge transfer element adapted to receive the first preceding boosting voltage from the first preceding VBC and provide the first preceding boosting voltage to the first output node.

10. The charge pump of claim 9, wherein the charge transfer element is a low-voltage transistor or a diode.

11. The charge pump of claim 7, wherein a second preceding VBC relative to the final VBC is adapted to precharge the final output node in accordance with a second precharge voltage of a second preceding output node of the second preceding VBC.

12. The charge pump of claim 7, wherein a second precharge voltage of a second preceding output node of a second preceding VBC relative to the final VBC has no effect on the final output node.

13. The charge pump of claim 1, wherein a second preceding VBC relative to the final VBC does not comprise any precharge circuit.

14. The charge pump of claim 13, wherein a third preceding VBC relative to the second preceding VBC is adapted to precharge a second preceding output node of the second preceding VBC in accordance with a third precharge voltage of a third preceding output node of the third preceding VBC.

15. The charge pump of claim 13, wherein a third precharge voltage of a third preceding output node of a third preceding VBC relative to the second preceding VBC has no effect on a second preceding output node of the second preceding VBC.
